(19) United States
(12) Patent Application Publication
(10) Pub. No.: US 2013/0104935 A1
(43) Pub. Date: May 2, 2013

(54) FILTER DETECTION SYSTEM FOR A DISHWASHING APPLIANCE

(71) Applicants: Errin Gnadinger, Louisville, KY (US); Satish Kumar Raju Buddharaju, Louisville, KY (US); Eric B. Devins, Louisville, KY (US)

(72) Inventors: Errin Gnadinger, Louisville, KY (US); Satish Kumar Raju Buddharaju, Louisville, KY (US); Eric B. Devins, Louisville, KY (US)

(73) Assignee: GENERAL ELECTRIC COMPANY, Schenectady, NY (US)

(21) Appl. No.: 13/287,436

(22) Filed: Nov. 2, 2011

(51) Int. Cl. A47L 15/46; B08B 3/00; A47L 15/00

(52) U.S. Cl. 134/18; 134/110; 134/56 D

(57) ABSTRACT

A system is provided for detecting whether a filter is properly installed in a dishwashing appliance and for using such detection in the operation of the appliance. For example, the present invention provides for determining whether a filter is present or properly seated and, if not, provides for a notification to the user of the appliance. The present invention can also provide for modifying the operation of the dishwashing appliance if a filter is not properly detected. Additionally, the present invention can provide notification to the user of the appliance that a filter needs replacement after a predetermined period of use.

### FIELD OF THE INVENTION

The subject matter of the present invention relates to detection of a properly seated filter in a dishwashing appliance and to the use of such detection in the operation of the appliance.

### BACKGROUND OF THE INVENTION

During wash and rinse cycles, dishwashers typically circulate a fluid through the wash chamber and over articles such as pots, pans, silverware, and other cooking utensils. The fluid can be e.g., various combinations of water and detergent during the wash cycle or water (which may include additives) during the rinse cycle. Typically the fluid is recirculated during a given cycle using a pump. Fluid is collected at or near the bottom of the wash chamber and pumped back into the chamber through e.g., nozzles in the spray arms and other openings that direct the fluid against the articles to be cleaned or rinsed.

Depending upon the level of soil upon the articles, the fluid will become contaminated with the soil in the form of debris and particles that are carried with the fluid. In order to protect the pump and make sure the fluid can continue to recirculate through the wash chamber, the fluid is typically filtered during its movement between the wash chamber and the pump so that relatively clean fluid is supplied to the pump inlet. In addition to pump protection, such filtration also helps to clean the articles by removing soil from the fluid.

For at least these reasons, dishwashing appliances are typically equipped with at least one filter to help remove soil particles from the recirculated fluid. Proper filtration of the fluid requires not only that the filter is present but also requires the filter to be properly secured or seated in the dishwashing appliance. The failure to properly seat the filter can result in unfiltered fluid leaking past or otherwise bypassing the filter. Improper seating can result e.g., when the filter is installed after cleaning or replacement.

A variety of filter media can be used to filter the fluid that is recirculated in the dishwasher. Mechanical filtration uses a media having fluid paths smaller than the soil particles to remove such particles from the fluid. For example, a mesh screen can be used to remove particles larger than apertures or openings in the screen. Eventually, such a filter may need cleaning or replacement so as remove particles that may become lodged in the filter media. If the filter becomes clogged, efficiently cleaning of the article in the dishwasher may be impeded unless corrective steps are taken such as e.g., cleaning or replacement.

Accordingly, a system for determining whether a filter is present in a dishwashing appliance would be useful. More particularly, a system that can determine whether a filter is present and/or properly seated and, if not, notify a user of the appliance would be beneficial. A system that can also modify the operation of the dishwashing appliance based on a filter that has not been timely cleaned or replaced would also be useful.

### BRIEF DESCRIPTION OF THE INVENTION

Aspects and advantages of the invention will be set forth in part in the following description, or may be obvious from the description, or may be learned through practice of the invention.

In one exemplary embodiment, the present invention provides a dishwashing appliance that includes a cabinet defining a wash chamber for the receipt of articles for washing. A pump is configured for the receipt of a fluid to be recirculated into the wash chamber of the cabinet. The pump has an inlet. A filter receptacle is configured to receive a filter for the filtering of fluid from the wash chamber prior to feeding such fluid to the inlet of the pump. A sensor is positioned with the filter receptacle and is configured for providing a signal if the filter is not detected by the sensor.

In another exemplary aspect, the present invention provides a method for operating a dishwashing appliance. The method includes the steps of detecting a replacement of a fluid filter of the appliance; measuring an elapsed interval of time, T_{INT}, after the step of detecting; ascertaining whether T_{INT} exceeds a predetermined value, T_{MAX}, and, if so, then, providing a notification to a user of the appliance that the fluid filter should be replaced.

In still another exemplary aspect of the invention, another method for operating a dishwashing appliance is provided. The method includes the steps of detecting a removal or improper positioning of a fluid filter of an appliance; providing a notification for a user of the appliance that a fluid filter for the appliance needs servicing; and prompting the user to select a special cycle of the appliance until the fluid filter is either replaced or properly positioned.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front, perspective view of an exemplary dishwashing appliance of the present invention.

FIG. 2 provides a side, cross-sectional view of the exemplary appliance of FIG. 1.

FIG. 3 provides a partial perspective view of the sump portion of an exemplary embodiment of a dishwashing appliance including the top of a filter and part of a spray arm assembly.

FIG. 4 illustrates a filter being received into the fluid receptacle of the sump portion depicted in FIG. 3.

FIGS. 5 and 6 provide cross-sectional views, taken along line C-C of FIG. 3, of a filter and a filter receptacle in the sump portion depicted in FIG. 3. In FIG. 5 the filter is shown removed from the filter receptacle. FIG. 6 depicts the filter received into the receptacle and properly seated for filtering operation.

### DETAILED DESCRIPTION OF THE INVENTION

The present invention provides a system for detecting whether a filter is properly installed in a dishwashing appliance and to the use of such detection in the operation of the appliance. More particularly, the present invention provides for determining whether a filter is present or properly seated and, if not, provides for a notification to the user of the appliance. The present invention can also provide for modifying the operation of the dishwashing appliance if a filter is not properly detected. Additionally, the present invention can provide notification to the user of the appliance that a filter needs replacement after a predetermined period of use. Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “article” may refer to but need not be limited to dishes, pots, pans, silverware, and other cooking utensils and items that can be cleaned in a dishwashing appliance. The term “wash cycle” is intended to refer to one or more periods of time during which a dishwashing appliance operates while containing the articles to be washed and uses a detergent and water, preferably with agitation, to e.g., remove soil particles including food and other undesirable elements from the articles. The term “rinse cycle” is intended to refer to one or more periods of time in which the dishwashing appliance operates to remove residual soil, detergents, and other undesirable elements that were retained by the articles after completion of the wash cycle. The term “fluid” refers to a liquid used for washing and/or rinsing the articles and is typically made up of water that may include other additives such as detergent or other treatments.

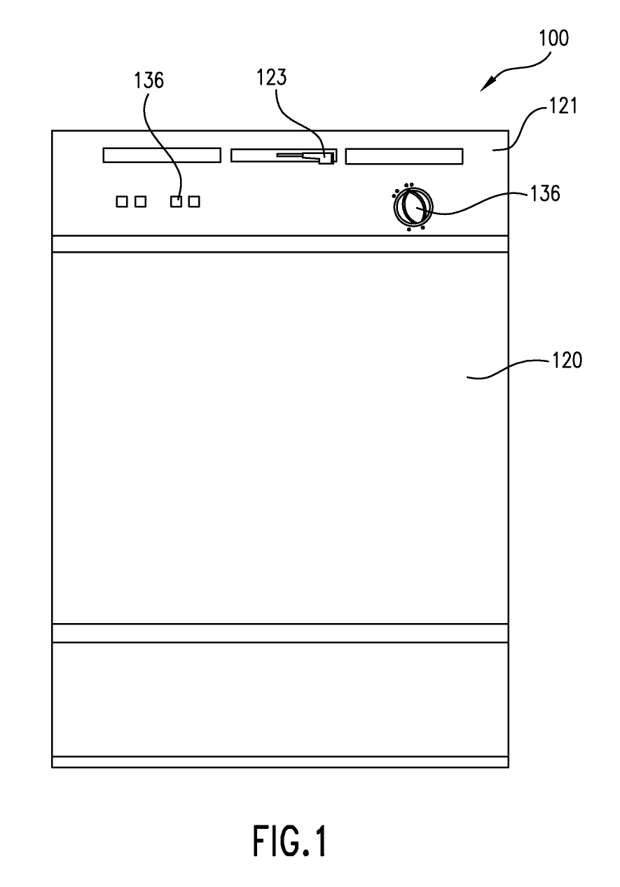

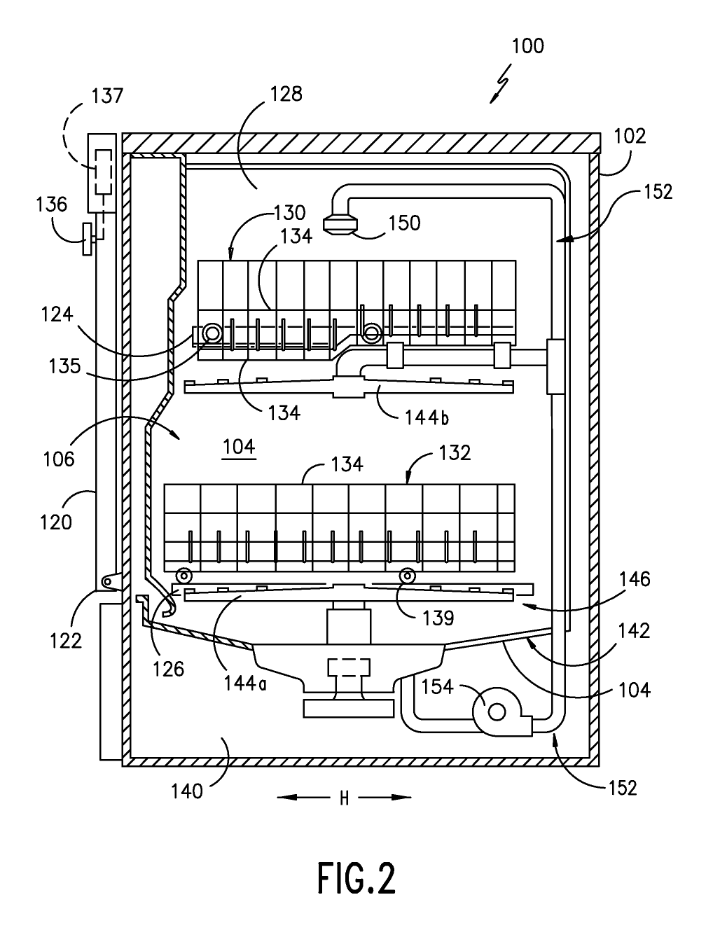

FIGS. 1 and 2 depict an exemplary domestic dishwasher 100 that may be configured in accordance with aspects of the present disclosure. For the particular embodiment of FIG. 1, the dishwasher 100 includes a cabinet 102 having a tub 104 therein that defines a wash chamber 106. The tub 104 includes a front opening (not shown) and a door 120 hinged at its bottom 122 for movement between a normally closed vertical position (shown in FIGS. 1 and 2), wherein the wash chamber 106 is sealed shut for washing operation, and a horizontal open position for loading and unloading of articles from the dishwasher. Latch 123 is used to lock and unlock door 120 for access to chamber 106.

Upper and lower guide rails 124, 126 are mounted on tub side walls 128 and accommodate roller-equipped rack assemblies 130 and 132. Each of the rack assemblies 130, 132 is fabricated into lattice structures including a plurality of elongated members 134 (for clarity of illustration, not all elongated members making up assemblies 130 and 132 are shown in FIG. 2). Each rack 130, 132 is adapted for movement between an extended loading position (not shown) in which the rack is substantially positioned outside the wash chamber 106, and a retracted position (shown in FIGS. 1 and 2) in which the rack is located inside the wash chamber 106. This is facilitated by rollers 135 and 139, for example, mounted onto racks 130 and 132, respectively. A silverware basket (not shown) may be removably attached to rack assembly 132 for placement of silverware, utensils, and the like, that are otherwise too small to be accommodated by the racks 130, 132.

The dishwasher 100 further includes a lower spray-arm assembly 144a that is rotatably mounted within a lower region 146 of the wash chamber 106 and above a tub sump portion 142 so as to rotate in relatively close proximity to rack assembly 132. A mid-level spray-arm assembly 144b is located in an upper region of the wash chamber 106 and may be located in close proximity to upper rack 130. Additionally, an upper spray assembly 150 may be located above the upper rack 130.

The lower and mid-level spray-arm assemblies 144a, 144b and the upper spray assembly 150 are fed by a fluid circulation assembly 152 for circulating water and dishwasher fluid in the tub 104. The fluid circulation assembly 152 may include a pump 154 located in a machinery compartment 140 located below the bottom sump portion 142 of the tub 104, as generally recognized in the art. Each spray-arm assembly 144, 148 includes an arrangement of discharge ports or orifices for directing washing liquid onto dishes or other articles located in rack assemblies 130 and 132. The arrangement of the discharge ports in spray-arm assemblies 144, 148 provides a rotational force by virtue of washing fluid flowing through the discharge ports. The resultant rotation of the lower spray-arm assembly 144 provides coverage of dishes and other dishwasher contents with a washing spray.

The dishwasher 100 is further equipped with a controller 137 to regulate operation of the dishwasher 100. The controller may include a memory and one or more microprocessors, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 137 may be positioned in a variety of locations throughout dishwasher 100. In the illustrated embodiment, the controller 137 may be located within a control panel area 121 of door 120 as shown. In such an embodiment, input/output (“I/O”) signals may be routed between the control system and various operational components of dishwasher 100 along wiring harnesses that may be routed through the bottom 122 of door 120. Typically, the controller 137 includes a user interface panel 136 through which a user may select various operational features and modes and monitor progress of the dishwasher 100. In one embodiment, the user interface 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. The user interface 136 may be in communication with the controller 137 via one or more signal lines or shared communication busses.

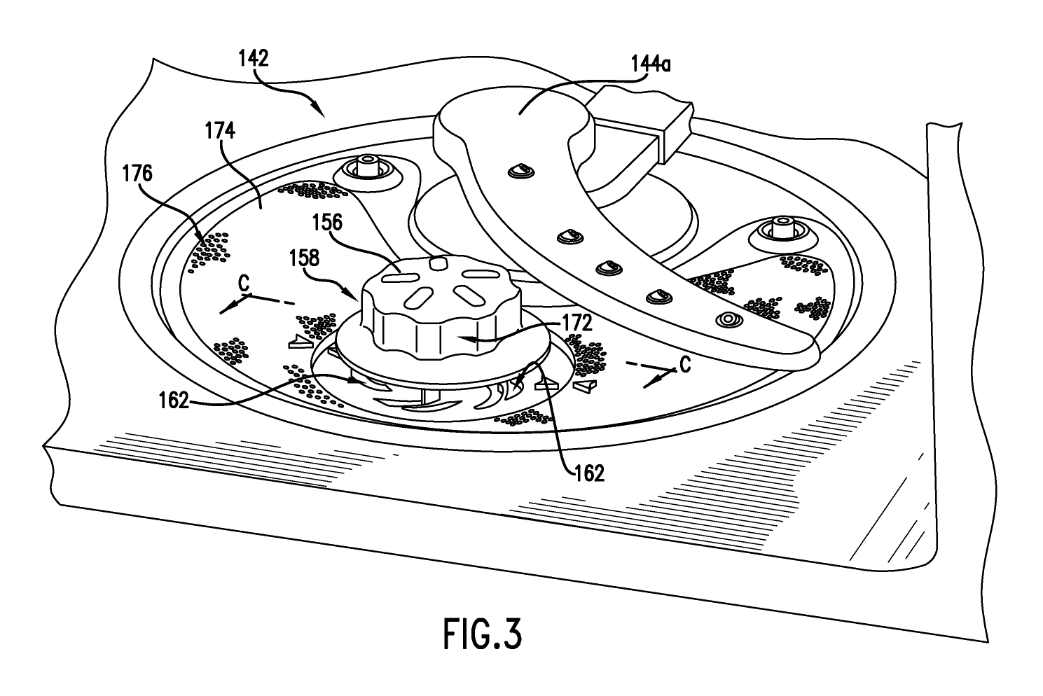

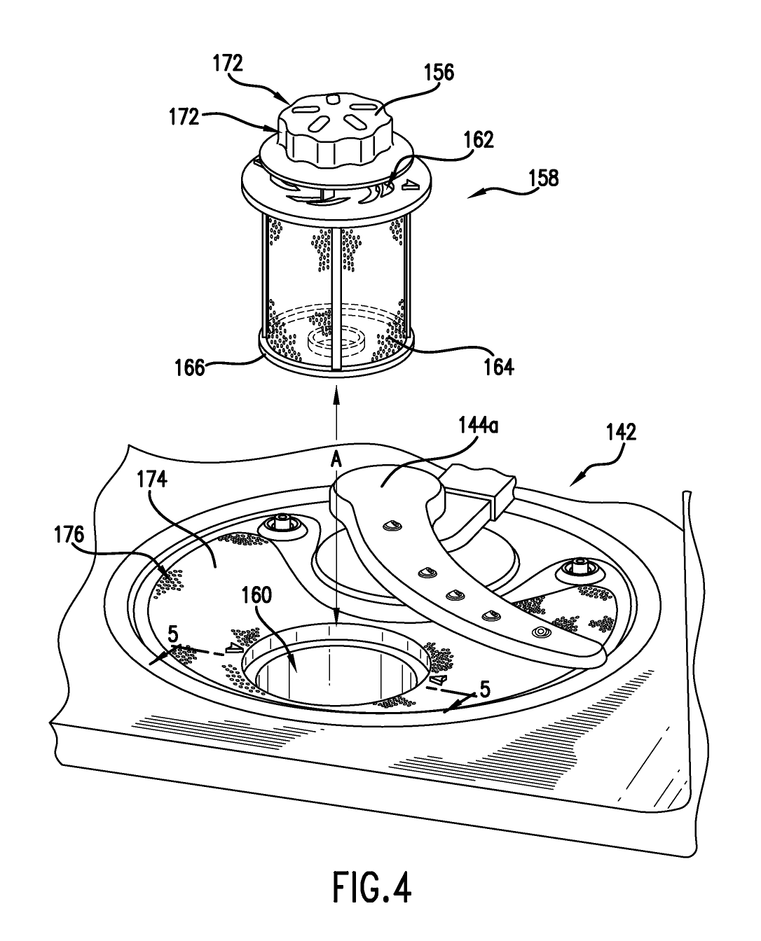

FIGS. 3 and 4 illustrate a partial perspective view of the sump portion 142 of an exemplary embodiment of a dishwashing appliance 100 including the top 156 of a filter 158 and part of lower spray arm assembly 144a. Sump portion 142 includes a grate 174 having a plurality of apertures 176 spaced thereon. Grate 174 assists with filtering relatively larger soil particles from fluid that travels down into sump portion 142 to be recirculated through the appliance 100 using pump 154 and fluid circulation assembly 152.

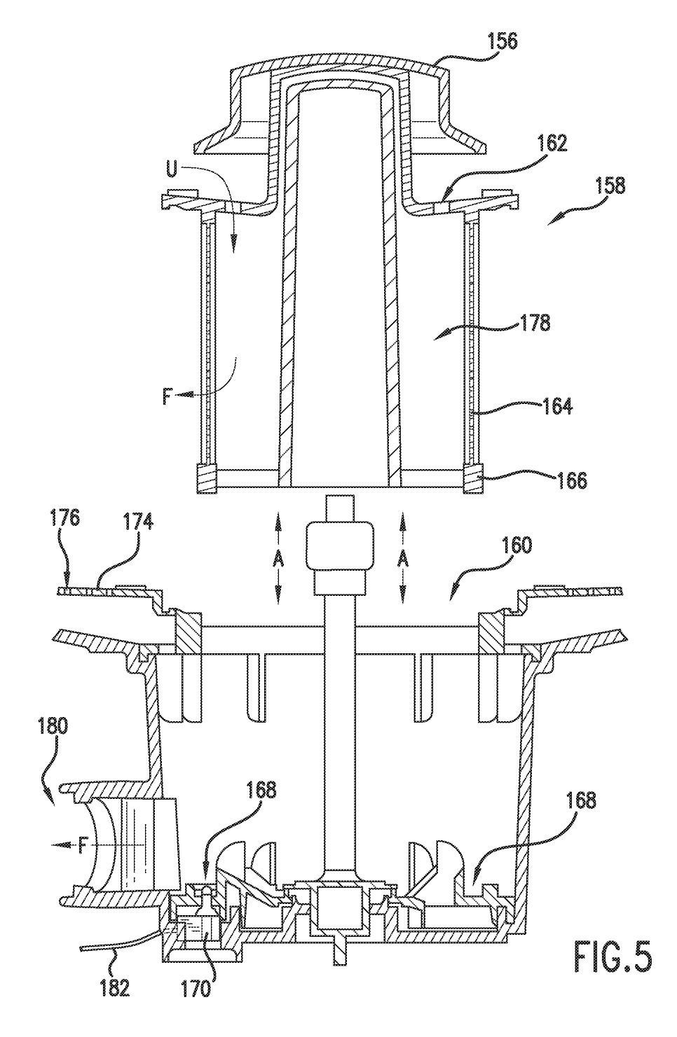

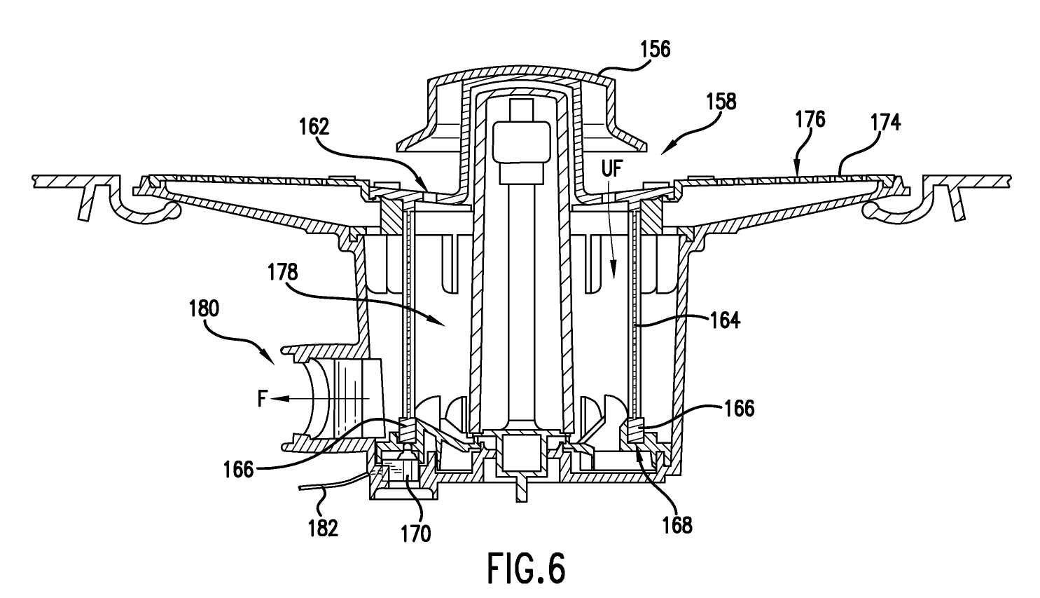

Filter 158 is removable from filter receptacle 160. Top 156 includes various indentations 172 to provide grip for the removal 158. Filter 158 includes a filter media 164 that may consist of e.g., a wire mesh or screen for the removal of soil particles from fluid that flows down into sump portion 142. Such fluid can flow into filter 158 through openings 162 near top 156. As shown by arrow UF in FIGS. 5 and 6, unfiltered fluid travels through openings 162 and into the interior 178 of filter 158. By travelling through filter media 164, filtered fluid can exit the interior of filter 158 as shown by arrows F and flow out of filter receptacle 160 by way of outlet 180. From outlet 180, the filtered fluid is returned to pump 154 for recirculation into tub 104 through e.g., spray assemblies 144a, 144b, and 150.

In one exemplary embodiment, filter media 164 may include smaller apertures than apertures 176 in grate 174 and, therefore, can be used to remove smaller soil particles from the fluid than would be removed by the apertures 176 in grate 174. As such, filter media 164 may need cleaning or replacement from time to time. As stated, filter 158 may be removed (as shown by arrows A) for cleaning or replacement by a service technician or a user of the appliance.

For proper operation of the filtering system of appliance 100, it is important that filter 158 is not only present but is also properly installed. More specifically, referring to FIGS. 5 and 6, filter 158 includes a bottom seat 166 that is received into a groove 168 located in the bottom of filter receptacle 160. When bottom seat 166 is properly positioned in groove 168, a seal is created so that fluid flows through filter media 164 as previously described instead of bypassing the media by travelling under the bottom seat 166.

Accordingly, in order to detect if filter 158 is properly seated, a sensor 170 is provide with filter receptacle 160. For this particular exemplary embodiment, sensor 170 is configured as a manual, contact switch that protrudes into groove 168. When filter 158 is present and properly positioned in filter receptacle 160, bottom seat 166 depresses sensor 170. In turn, the depression of sensor 170 provides a signal that indicates that filter 158 is present. Alternatively, when filter 158 is removed or is not properly positioned such that bottom seat 166 and groove 168 form a proper seal, then sensor 170 will not be depressed. As such, a signal is provided by sensor 170 that indicates filter 158 is not detected—either because filter 158 is absent or not properly positioned.

For this particular example, sensor 170 is configured as a manual, contact switch (such as a microswitch) that e.g., provides a signal through wires 182 by either opening or closing a circuit. However, as will be understood by one of ordinary skill in the art using the teachings disclosed herein, the present invention is not limited to this particular type of sensor 170 or the configuration shown in FIGS. 5 and 6. Other configurations and sensor types may be used as well to provide for a signal that indicates whether or not filter 158 is properly detected. For example, alternative embodiments of the present invention can include a reed switch and magnet, Hall sensor with magnet, optical beams, pressure sensor, capacitive sensors, and other types and configurations as well.

The signal provided by sensor 170 can be used in a variety of methods to improve the operation of dishwashing appliance 100. By way of example, upon receiving a signal from sensor 170, a notification can be provided to e.g., a user of the appliance to indicate that filter 158 should be inspected because it is either not present or is improperly positioned. For example, controller 137 can be configured to receive a signal from sensor 170 and then provide a notification to the user of the appliance through a light or other indicator on control panel area 121. Alternatively or in addition thereto, controller 137 could also modify the operation of appliance 100. For example, controller 137 could be configured to prompt the user to select a special cleaning cycle of the appliance until the filter 158 is installed or properly positioned. Such special cleaning cycle may include a modified wash cycle and/or modified rinse cycle to respond to the signal indicating that filter 158 is either missing or not properly positioned. Alternatively, controller 137 could be configured to automatically elect such special cleaning cycle until filter 158 is installed or properly positioned.

Alternatively or in addition thereto, controller 137 can also be configured to use one or more signals from sensor 170 to determine when the user should be notified that filter 158 needs replacement or cleaning. For example, upon receipt of a signal from sensor 170 indicating that filter 158 has been removed, it can be assumed the such removal is due to a cleaning or replacement. Accordingly, controller 137 can be configured to measure an elapsed time interval, T_{INT}, after a signal is received from sensor 170. Controller 137 can then compare T_{INT} with a predetermined value of time, T_{MAX}, determined by e.g., the manufacturer of the appliance. T_{MAX} could be e.g., a predetermined amount of time after which filter 158 should be cleaned or replaced. Alternatively, T_{INT} could be the number of wash cycles executed by the appliance since receipt of a signal from sensor 170, and T_{MAX} could be a predetermined maximum limit on the number of wash cycles the appliance 100 can execute before filter 158 should be cleaned or replaced. Other examples for T_{MAX} may be used as well.

Regardless, once controller 137 determines that T_{INT} meets and/or exceeds T_{MAX}, controller 137 can be configured to take one or more actions. For example, controller 137 can provide a notification to the user that filter 158 should be replaced. A visual and/or audible notification could be provided using control panel area 121. Alternatively, or in addition thereto, controller 137 could be configured to modify the operation of the appliance. For example, controller 137 could be configured to prompt the user to select a special cleaning cycle of the appliance until the filter 158 is replaced. Such special cleaning cycle may include a modified wash cycle and/or modified rinse cycle. Alternatively, controller 137 could be configured to automatically elect such special cleaning cycle until filter 158 is properly replaced.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwashing appliance, comprising:
a cabinet defining a wash chamber for the receipt of articles for washing;
a pump configured for the receipt of a fluid to be recirculated into the wash chamber of said cabinet, said pump having an inlet;
a filter receptacle configured to receive a filter for the filtering of fluid from the wash chamber prior to feeding such fluid to the inlet of said pump; and
a sensor positioned with said filter receptacle and configured for providing a signal if said filter is not detected by said sensor.

2. A dishwashing appliance as in claim 1, further comprising:
a controller configured for
receiving the signal provided by said sensor; and
providing a notification for a user of the appliance so as to indicate that the filter was not detected by said sensor.

3. A dishwashing appliance as in claim 1, further comprising:
a controller configured for
receiving the signal provided by said sensor; and
measuring an elapsed interval of time, T_{INT}, after receiving the signal from said sensor;
ascertaining whether T_{INT} exceeds a predetermined value, T_{MAX}, and, if so, then,
providing a notification to a user of the appliance to indicate that the filter should be replaced.

4. A dishwashing appliance as in claim 1, further comprising:
a controller configured for
receiving the signal created by said sensor; and
measuring an elapsed interval of time, T_{INT}, after receiving the signal from said sensor;
ascertaining whether T_{INT} exceeds a predetermined value, T_{MAX}, and, if so, then,
modifying the operation of the appliance.

5. A dishwashing appliance as in claim 4, wherein said modifying comprises selecting a special cleaning cycle.

6. A dishwashing appliance as in claim 1, further comprising:
a controller configured for
receiving the signal created by said sensor; and
measuring an elapsed interval of time, T_{INT}, after receiving the signal from said sensor;
ascertaining whether T_{INT} exceeds a predetermined value, T_{MAX}, and, if so, then,
providing a notification to a user of the appliance to indicate that the filter should be replaced, and
modifying the operation of the appliance.

7. A dishwashing appliance as in claim 6, wherein said modifying comprises selecting a special cleaning cycle.

8. A dishwashing appliance as in claim 1, further comprising:
a controller configured for
receiving the signal created by said sensor; and
modifying the operation of the appliance to account for the absence of the filter or improper placement of the filter.

9. A dishwashing appliance as in claim 1, further comprising:
a controller configured for
receiving the signal created by said sensor; and
prompting the user to select a special cleaning cycle of the appliance.

10. A dishwashing appliance as in claim 1, further comprising:
a controller configured for
receiving the signal created by said sensor; and
storing information regarding the time at which the signal was received so that the frequency of cleaning of the filter may be determined.

11. A dishwashing appliance as in claim 1, further comprising:
a filter received into said filter receptacle.

12. A method for operating a dishwashing appliance, comprising the steps of:
detecting a replacement of a fluid filter of the appliance;
measuring an elapsed interval of time, T_{INT}, after said step of detecting;
ascertaining whether T_{INT} exceeds a predetermined value, T_{MAX}, and, if so, then,
providing a notification to a user of the appliance that the fluid filter should be replaced.

13. A method for operating a dishwashing appliance as in claim 12, further comprising the step of modifying the operation of the appliance until the fluid filter is replaced.

14. A method for operating a dishwashing appliance as in claim 12, further comprising the step of prompting the user to select a special cleaning cycle of the appliance.

15. A method for operating a dishwashing appliance as in claim 12, further comprising the step of operating the appliance in a special cleaning cycle until the fluid filter is replaced.

16. A method for operating a dishwashing appliance, comprising the steps of:
detecting a removal or improper positioning of a fluid filter of an appliance;
providing a notification for a user of the appliance that a fluid filter for the appliance needs servicing; and
prompting the user to select a special cycle of the appliance until the fluid filter is either replaced or properly positioned.

17. A method for operating a dishwashing appliance as in claim 16, further comprising the step of operating the appliance in a special cleaning cycle.
